(19) United States
(12) Patent Application Publication
(10) Pub. No.: US 2009/0003955 A1
(43) Pub. Date: Jan. 1, 2009

(54) MACHINE TOOL

(75) Inventors: TAKEO NAKAGAWA, Tokyo (JP); JUN-QI LI, Shenzhen (CN); FUMIO NAKAMURA, Tokyo (JP); QING LIU, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/954,230

(22) Filed: Dec. 12, 2007

(30) Foreign Application Priority Data
Jun. 28, 2007 (CN) 200710200913.8

(51) Int. Cl. B23C 5/00; B23C 1/00

(52) U.S. Cl. 409/234; 409/225

(57) ABSTRACT

An exemplary machine tool includes a base and a drill for machining a specimen mounted on the base. The drill includes a main rotator and a bit holder mounted to the main rotator. The bit holder has a first rotator and a second rotator rotatably mounted to the bit holder. A first bit is mounted on the first rotator. A second bit is mounted on the second rotator. The machine tool has high precision and efficiency.

### CROSS-REFERENCE TO RELATED APPLICATIONS

This application is related to three co-pending U.S. patent applications, which are: application Ser. No. 11/944,465, Ser. No. 11/944,467, filed on November 23, and all entitled “MACHINE TOOL”, byjun-Qi Li et al. Such applications have the same assignee as the instant application and are concurrently filed herewith. The disclosure of the above-identified applications is incorporated herein by reference.

### BACKGROUND OF THE INVENTION

1. Field of the Invention

The present invention relates to machine tools, and particularly to, a machine tool that can perform a rough machining process and precision machining process.

2. Discussion of the Related Art

Typically, machine tools are preferred over manual tools because the machine tools exhibit high automatization, high machining precision, and other advantages. Therefore, machine tools are widely used in the manufacturing field.

In order to improve the precision of the machine tool, a typical machining process is separated into a rough machining step and a precision machining step. In the rough machining step, the item to be machined is machined to a crude facsimile, of the desired end product, and is called a preform. This preform is an approximately shape of the end product. In the precision machining step, the preform is then precisely machined to the shape of the end product.

A rough machining tool is used in the rough machining step while a precision machining tool is used in the precision machining step. FIG. 5 illustrates a rough machining tool 10. The rough machining tool 10 includes a C-shaped frame 11, a drill 13, a saddle member 16 and a slidable platform 17. The C-shaped frame 11 includes a base portion 111 and an overhanging upper portion 112. The drill 13 is installed on the overhanging upper portion 112 and the drill 13 can move in a direction parallel to a Z-axis. The drill 13 includes a rotator 132 and a rough cutting tool 134 installed at the end of the rotator 132. The rough cutting tool 134 can be driven to rotate by the rotator 132. A slide 15 on the base portion 111 extends along a direction parallel to the X-axis. The saddle member 16 is disposed on the slide 15 and can move in the direction parallel to the X-axis. The slidable platform 17 is disposed on the saddle member 16 and can move in a direction perpendicular to the X-axis and the Z-axis. During the rough machining step, a workpiece held by the slidable platform 17 can be machined to a rough product via a rotation of the rough cutting tool 134.

After the rough machining step, the preform is taken from the slidable platform 17, and mounted on a slidable platform of the precision machining tool. The precision machining tool has the same structure with the rough machining tool except for the drill 13. The quantity of material cut from the preform by the drill of the precision machining tool, is less than the quantity of material cut from the original workpiece by the drill 13 of the rough machining tool 10 each time, in order to make the precise machine tool have a higher machining precision than the rough machining tool 10.

Since the present machining process needs a rough machining tool and a precise machining tool to complete, the rough product must be transferred from the rough machining tool to the precision machining tool and must be mounted on the slidable platform of the precision machining tool. However, this transferring and mounting process takes time. Further this remounting of the preform, on the precision machining tool, may subject the perform to positional errors. Due to this deviation of position, the final product may not be of a high machining precision.

Therefore, a machine tool which can perform a rough machining process and a precision machining process, in order to avoid transferring and remounting unfinished machined product, is desired.

### SUMMARY

An exemplary machine tool includes a base and a drill for machining a specimen mounted on the base. The drill includes a main rotator and a bit holder mounted to the main rotator. The bit holder has a first rotator and a second rotator rotatably mounted to the bit holder. A first bit is mounted on the first rotator. A second bit is mounted on the second rotator.

Other advantages and novel features will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present machine tool. Moreover, in the drawings, like reference numerals designate corresponding parts throughout the several views, and all the views are schematic.

FIG. 1 is an isometric view of a machine tool according to an embodiment of the present invention.

FIG. 2 is an isometric view of a main equipment of the machine tool of FIG. 1.

FIG. 3 is an isometric view of the main equipment of FIG. 2 without a cover thereof.

FIG. 4 is an isometric view of a tool support of the main equipment of FIG. 3.

FIG. 5 is a side isometric view of a machine tool according to a conventional machine tool.

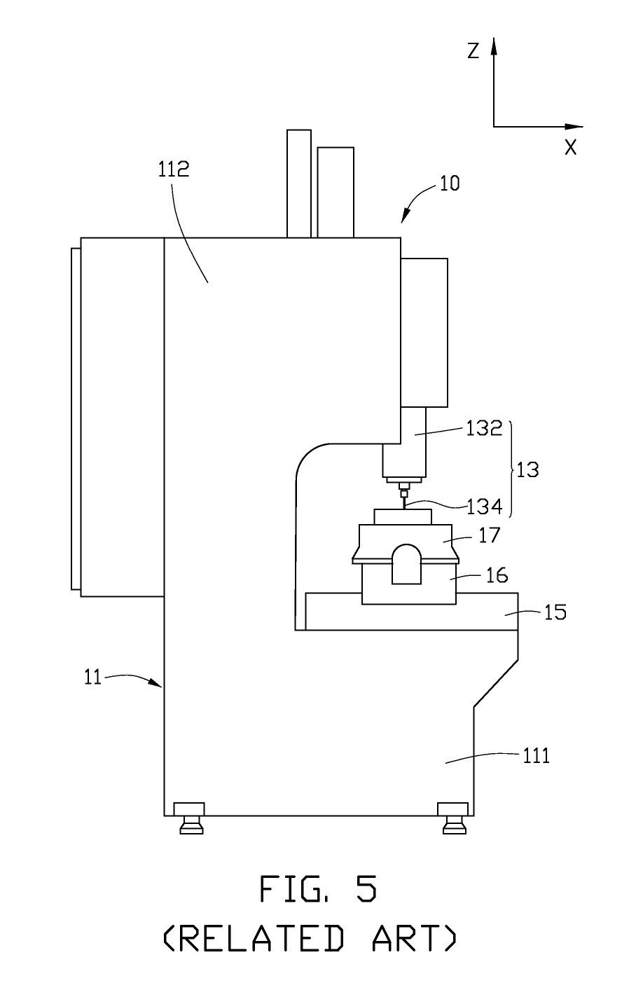

### DETAILED DESCRIPTION OF THE EMBODIMENTS

The present invention provides a machine tool. An exemplary machine tool is described in detail as follows.

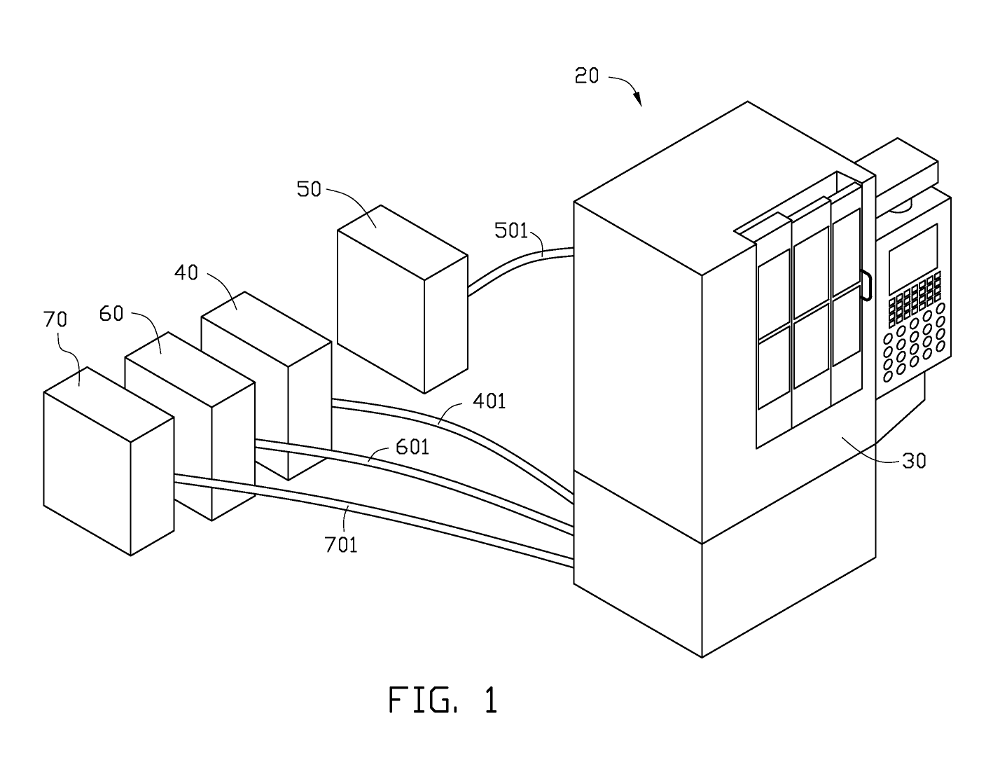

Referring to FIG. 1, a milling machine is taken as an example of a machine tool 20, and includes a main equipment 30, a power cabinet 40, a dust remover equipment 50, a compressor 60, and a cooling equipment 70. Alternatively, the machine tool 20 can be other types of machines such as lathes and grinding machines.

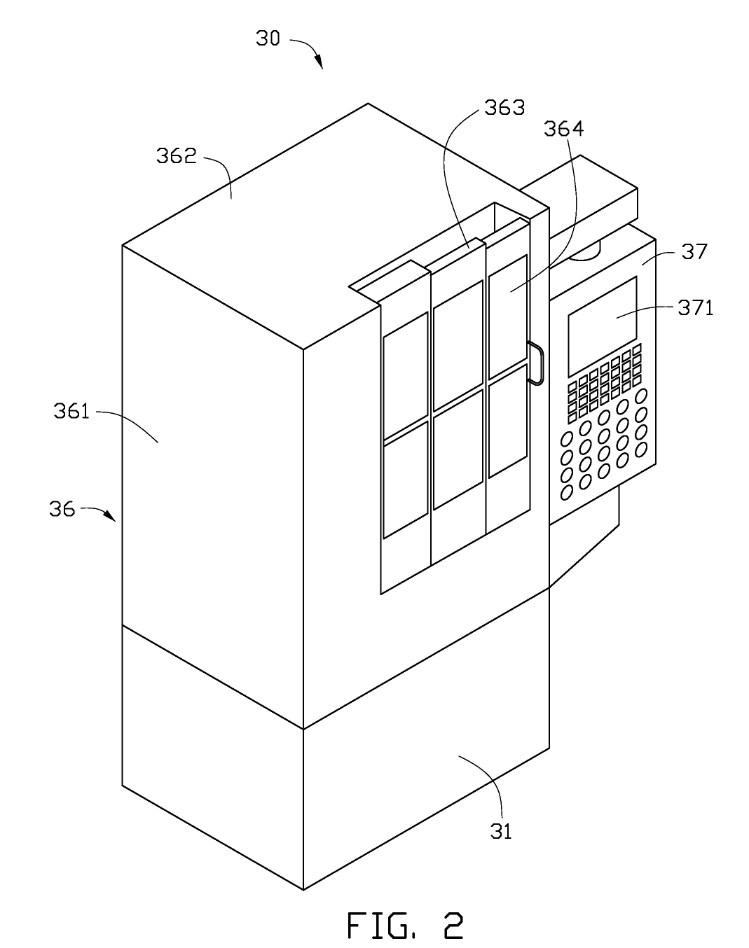

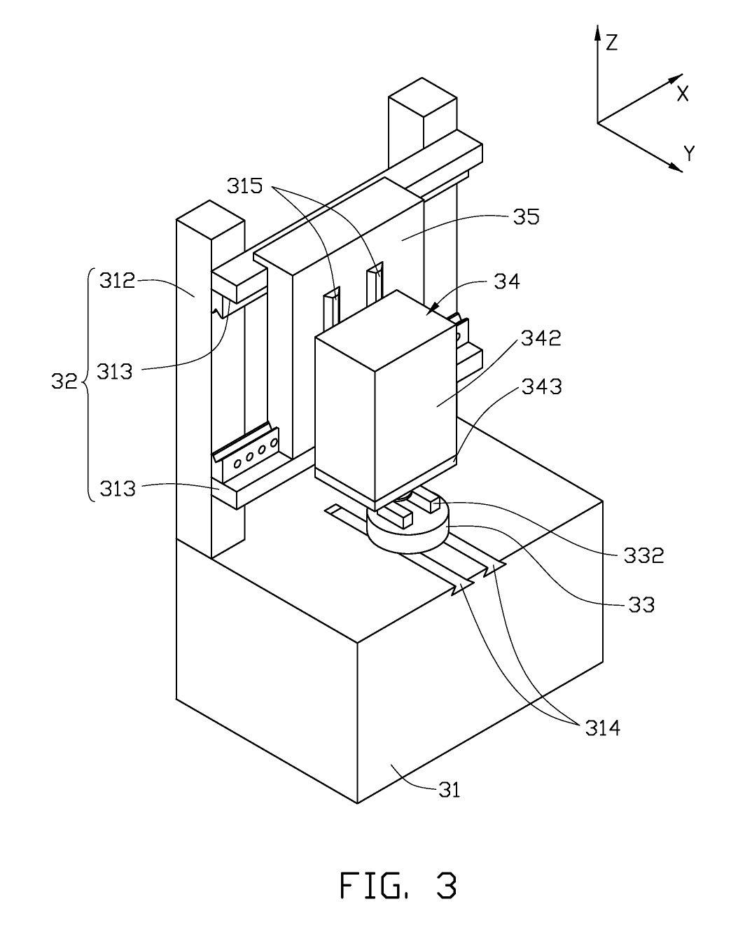

Referring to FIGS. 2 and 3, the main equipment 30 includes a base 31, a tool rack 32, a slidable platform 33, a drill 34, a drill holder 35, a cover 36, and a controller 37.

The base 31 includes a top surface 311. A pair of guiding grooves 314 are defined in the top surface 311 of the base 31. As seen in FIG. 3, the pair of guiding grooves 314 runs parallel to the Y-axis and are configured for receiving the slidable platform 33 and guiding the slidable platform 33 to move parallel to the Y-axis.

The tool rack 32 includes a pair of support arms 312 extending perpendicular from the top surface of the base 31. As also seen in FIG. 3, the pair of support arms 312 extend parallel to the Z axis. A pair of horizontal guide rails 313 are fixed between the pair of support arms 312. The horizontal guide rails 313 run parallel to the X-axis and are configured for receiving the drill holder 35 and guiding the drill holder 35 to slide parallel to the X-axis.

A pair of vertical guiding chutes 315 are defined in the drill holder 35. The pair of vertical guiding chutes 315 run parallel to the Z-axis and are configured for receiving the drill 34 and guiding the drill 34 to slide parallel to the Z-axis.

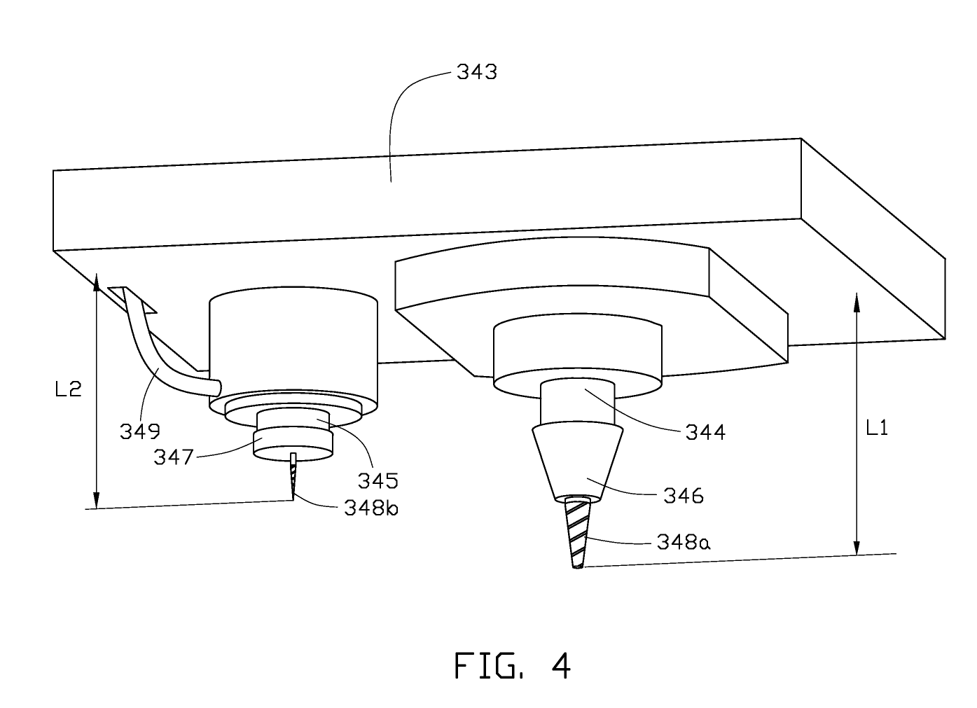

Referring to FIG. 3 and FIG. 4, the drill 34 is slidably attached to the drill holder 35 and includes a main rotator 342 and a bit holder 343. The bit holder 343 includes a first driver (not labeled) and a second driver (not labeled). The first driver includes a first rotator 344 and a first chuck 346. The first chuck 346 is configured for receiving a first bit 348a and for driving the first bit 348a to rotate/spin around an axis parallel to the Z-axis. The second driver includes a second rotator 345 and a second chuck 347. The second chuck 347 is configured for receiving a second bit 348b and for driving the second bit 348b to rotate/spin around an axis parallel to the Z-axis.

The slidable platform 33 includes two clamps 332 disposed thereon. The clamps 332 are driven by air pressure to hold/release a workpiece (not shown). The slidable platform 33 is made of aluminum alloy with a density in a range from about 2.7×10³ kilogram per cubic meter (kg/m³) to about 3.3×10³ kg/m³.

Since the slidable platform 33 is made of aluminum alloy, the slidable platform 33 is lighter than a slidable platform that is made of cast iron because the density of aluminum alloy is smaller than that of cast iron. Due to a relatively lighter weight, when the slidable platform 33 slides on the base 31, there will be less friction, thus when the slidable platform 33 slides into a predetermined position on the base 31, frictional force and momentum force affecting the slidable platform is small. As a result, not only can the base 31 stably slide on the slidable platform 33 with very little deviation, but can also reduce a weight and a volume of the machine tool 20. The machine tool 20 can be miniaturized. In the manufacturing field, it is known that miniaturized machine tools are particularly suitable for super precision manufacturing. Furthermore, precise movement of the slidable platform 33 is improved because the slidable platform 33 is relatively light. Therefore, the precision of the machine tool 20 is increased.

The first rotator 344 is driven to rotate by an electric motor and the second rotator 345 is driven to rotate by compressed air. Compressed air is transmitted to the second rotator 345 via an air pipe 349. A rotational speed of the first rotator 344 is in a range from about 3000 revolutions per minute (rpm) to about 50000 rpm. A rotational speed of the second rotator 345 is in a range from about 50000 rpm to about 160000 rpm, and is preferred to be in a range from about 120000 rpm to about 160000 rpm. Preferably, the rotational speed of the first rotator 344 is about 50000 rpm, and the rotational speed of the second rotator 345 is about 160000 rpm.

The drill 34 has a high conductivity because it is made of aluminum alloy with a density of about 2.7×10³ kg/m³ to about 3.3×103 kg/m³. Because the drill 34 has a high conductivity, the heat generated when the first and second rotators 344, 345 rotate can be efficiently dispersed through the drill 34. Thus, deformations of the first and second rotators 344, 345 due to high temperatures can be prevented, and thus prolonging the life of the machine tool 20.

The first bit 348a is a rough tool and the second bit 348b is a precision tool. A diameter of the first bit 348a is in a range from about 1 millimeter to about 6 millimeters. A diameter of the second bit 348b is in a range from about 0.05 millimeters to about 1 millimeter.

In the manufacturing field, in order to improve a machining precision, precision tools are made having small diameters. Since a cutting force in precision machining is small; that is, smaller than a cutting force in rough machining, precision tools having small diameters are not as strong as precision tools with large diameters. Precision tools are often driven to rotate with high rotational speed so as to improve an efficiency of machining, therefore, in the present invention, the first bit 348a with a larger diameter, mounted to the first rotator 344 having a lower rotational speed is adopted for rough machining, similarly, the second bit 348b with a smaller diameter, is mounted to the second rotator 345 having a higher rotational speed, is adopted for precision machining. In the embodiment, a workpiece (not shown) is machined by the first bit 348a first. Then, the first bit 348a is removed from the first rotator 344. Next, the workpiece is machined by the second bit 348b. In the preferred embodiment, a distance L₁ from a bottom of the bit holder 343 to a distal end of the first bit 348a is larger than a distance L₂ from a bottom of the bit holder 343 to a distal end of the second bit 348b.

Referring to FIG. 2 again, the cover 36 includes four sidewalls 361 and a top ceiling 362 connected to the sidewalls 361. Each sidewall 361 correspondingly connects to two other sidewalls 361. The sidewalls 361 and the top wall 362 cooperatively form a cavity. The cover 36 is sleeved over the base 31 and receives the drill 34, the slidable platform 33, and the tool rack 32 therein. The cover 36 further includes a door 363 assembled on one of the sidewalls 361. The door 363 has a plurality of observing windows 364. When opened, the machining process can be monitored through the windows 364.

The controller 37 is positioned at one side of the cover 36 and is adjacent the movable door 363. The controller 37 is used to control movements of the drill holder 35, the slidable platform 33, and the drill 34. The controller 37 has a display 371 to display machining parameters such as the positions of the first bit 348a, the second bit 348b, the slidable platform 33, and rotational speeds of the first bit 348a and the second bit 348b.

Referring to FIG. 1 again, the power cabinet 40, the dust remover equipment 50, the compressor 60, and the cooling equipment 70 are separate by some distance from the main equipment 30. In an embodiment, the power cabinet 40, the dust remover equipment 50, the compressor 60, the cooling equipment 70 and the main equipment 30 can even be placed in different locations. The power cabinet 40 is connected to the main equipment 30 by cables 401. The dust remover equipment 50 is connected to the cover 36 via a pipe 501 for absorbing dust and oil fog inside the cover 36. The compressor 60 is connected to the main equipment 30 via a windpipe 601, and provides pressurized air to the slidable platform 33 and the second rotator 345. The cooling equipment 70 has a cooling pipe 701 extending to an inside of the main equipment 30. The cooling pipe 701 is filled with a cooled liquid so as to cool components of the main equipment 30 such as the bit holder 343.

In the present application, heat generated from the power cabinet 40 is not transferred to the main equipment 30 because the power cabinet 40 is separated and far away from the main equipment 30. Therefore, the heat produced by the power cabinet 40 does not compromise the precision of the machine tool 20. During operation, the dust remover equipment 50, the compressor 60, and the cooling equipment 70 vibrates. This vibration will not affect the main equipment 30 because the dust remover equipment 50, the compressor 60, and the cooling equipment 70 are located separately from the main equipment 30, thus, the precision of the machine tool 20 is maintained. Furthermore, heat generated by the dust remover equipment 50, the compressor 60 and the cooling equipment 70 is not transferred to the main equipment 30 either. In addition, the machine tool 20 can be easily relocated because the peripheral equipments, such as the power cabinet 40, the dust remover equipment 50, the compressor 60, and the cooling equipment 70 are separated from main equipment 30. However, an integral machine tool that is large and heavy is difficult to be transported and relocated. Alternatively, the machine tool 20 can only include one, two or three peripheral equipments separate from the main equipment 30. In the preferred embodiment, the precision of the machine tool 20 is increased when all peripheral equipment are separate from the main equipment 30.

The operation of the machine tool 20 is described as follows. A workpiece is put on the slidable platform 33 of the main equipment 30 and held by the clamps 332 driven by air pressure. The drill holder 35, the slidable platform 33 and the drill 34 slides along the horizontal guide rails 313, the guiding grooves 314 and the vertical guiding chutes 315, i.e., parallel to the X-axis, Y-axis and Z axis, until the drill holder 35, the slidable platform 33 and the drill 34 reach an original position. Paths of the drill holder 35, the slidable platform 33 and the drill 34 are controlled by the controller 37. Then the drill holder 35, the slidable platform 33 and the drill 34 slide and the first rotator 344 rotate according to a program stored in the controller 37 to perform the roughing machining. Afterwards, the first chuck 346 and the first bit 348a are removed from the first rotator 344. The slidable platform 33 is moved through a predetermined distance, i.e., a distance between axes of the first and second rotators 344, 345, parallel to the Y-axis. Then the drill holder 35, the slidable platform 33, the drill 34 slide and the second rotator 345 rotates according to the program stored in the controller 37 to perform the precision machining.

The machine tool 20 has the first and second rotators 344, 345 with different rotational speeds and the first and second bits 348a, 348b with different diameters.

In the preferred embodiment, because, the 344,345 of the machine tool 20 rotate at different rpms, and the first and second bits 348a, 348b have different diameters, the machine tool 20 can perform both roughing machining and precision machining. In addition, during the roughing machining and precision machining, the workpiece is only clamped (hold/release) once, thus, giving the first bit 348a can be removed by a tool removing device automatically. Alternatively, the first and second chucks 346, 347 and the first and second rotators 344, 345 can be retractable. Thus, the first bit 348a retracts before precision machining, and the first chuck 346 and the first bit 348a does not need to be removed from the machine tool 20.

In alternative embodiments, besides the slidable platform 33 and the drill 34, other movable components such as the drill holder 35 can be made of aluminum alloy with a density in a range from about 2.7×10³ kg/m³ to about 3.3×10³ kg/m³. Thereby, the machine tool 20 has a higher precision and a smaller volume. Also, the movable components can be made of other metal or alloy with small density such as magnesium alloy. The metal or alloy should be have a density of in a range from about 1.7×10³ kg/m³ to about 3.3×10³ kg/m³. The first and second bits 348a, 348b can be any kinds of cutting tools such as milling cutters.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

1. A machine tool comprising:
a base;
a drill for machining a specimen mounted on the base, the drill having:
a main rotator;
a bit holder mounted to the main rotator, and the bit holder having a first rotator and a second rotator rotatably mounted to the bit holder, wherein the first rotator and the second rotator are substantially parallel to each other; and
a first bit mounted on the first rotator and a second bit mounted on the second rotator, wherein a diameter of the first bit is different from that of the second bit.

2. The machine tool as claimed in claim 1, wherein a diameter of the first bit is in a range from about 1 millimeter to about 6 millimeters.

3. The machine tool as claimed in claim 1, wherein a diameter of the second bit is in a range from about 0.05 millimeters to about 1 millimeter.

4. The machine tool as claimed in claim 1, wherein a rotate speed of the first rotator is in a range from about 3000 r/min to about 50000 r/min, and a rotate speed of the second rotator is in a range from about 50000 r/min to about 160000 r/min.

5. The machine tool as claimed in claim 1, wherein the rotate speed of the first rotator is about 50000 r/min, and the rotate speed of the second rotator is about 160000 r/min.

6. The machine tool as claimed in claim 18, wherein the first rotator is driven by an electric motor, and the second rotator is driven by compressed air.

7. The machine tool as claimed in claim 1, wherein the bit holder is made of metal or alloy with a density from about 1.7×10³ kg/m³ to about 3.3×10³ kg/m³.

8. The machine tool as claimed in claim 1, wherein the bit holder is made of aluminum alloy with a density from about 2.7×10³ kg/m³ to about 3.3×10³ kg/m³.

9. The machine tool as claimed in claim 1, wherein the base comprises a top surface, the machine tool further comprises a tool rack and a drill holder, the tool rack comprises at least one support arm extending perpendicular from the top surface of the base, the at least one support arm is parallel to a vertical first direction, at least one horizontal guide rail is fixed to the at least one support arm, the at least one horizontal guide rail is parallel to a second direction perpendicular to the first direction, and is configured for receiving the drill holder and guiding the drill holder to slide parallel to the second direction.

10. The machine tool as claimed in claim 9, wherein the tool rack comprises a pair of support arms and a pair of horizontal guide rails, the pair of horizontal guide rails are fixed between the pair of support arms.

11. The machine tool as claimed in claim 9, wherein the machine tool further comprises a slidable platform, at least one guiding groove is defined in the top surface of the base, the at least one guiding groove runs parallel to a third direction perpendicular to the first and second directions, and are configured for receiving the slidable platform and guiding the slidable platform to move parallel to the third direction.

12. The machine tool as claimed in claim 11, wherein at least one vertical guiding chute is defined in the drill holder, the at least one vertical guiding chute is parallel to the first direction, the at least one vertical guiding chute is configured for receiving the drill and guiding the drill to slide parallel to the first direction.

13. The machine tool as claimed in claim 12, wherein at least one of the slidable platform and the drill holder is made of metal or alloy with a density from about 1.7×10³ kg/m³ to about 3.3×10³ kg/m³.

14. The machine tool as claimed in claim 12, wherein at least one of the slidable platform and the drill holder is made of aluminum alloy with a density from about 2.7×10³ kg/m³ to about 3.3×10³ kg/m³.

15. The machine tool as claimed in claim 11, wherein the machine tool further comprises a controller for controlling the movements of at least one of the slidable platform, the first rotator and the second rotator.

16. The machine tool as claimed in claim 11, wherein the machine tool further comprises a cover, the cover covers the base and receives the drill holder, the slidable platform, and the drill therein.

17. The machine tool as claimed in claim 1, wherein a distance from a bottom of the bit holder to a distal end of the first bit is larger than a distance from a bottom of the bit holder to a distal end of the second bit.

18. The machine tool as claimed in claim 1, wherein a driving mode of the first rotator is different from that of the second rotator.
